(19) United States
(12) Patent Application Publication
(10) Pub. No.: US 2013/0293999 A1
(43) Pub. Date: Nov. 7, 2013

(54) PROTECTION CIRCUIT FOR ELECTRONIC APPARATUS

(71) Applicant: XING-HUA TANG, Shenzhen (CN)

(72) Inventor: XING-HUA TANG, Shenzhen (CN)

(21) Appl. No.: 13/685,648

(22) Filed: Nov. 26, 2012

(30) Foreign Application Priority Data
May 3, 2012 (CN) 201210133574.7

(51) Int. Cl. H02H 9/02

(52) U.S. Cl. CPC H02H 9/02
USPC 361/118

(57) ABSTRACT

A protection circuit includes a relay, a reset switch, a voltage conversion circuit, and a rectifier circuit. The voltage conversion circuit is connected to an AC power supply via the reset switch, and converts a voltage of the AC power supply to a low AC voltage. The rectifier circuit converts the low AC voltage to a direct current voltage and powers a coil of the relay. At least one item of electronic apparatus is powered by the AC power supply via contacts of the relay or the reset switch. If the main power is lost, the relay releases, and the power connection must be re-established by pressing the reset switch after the AC power supply has been restored, thus energizing the relay to latch on the AC power supply.

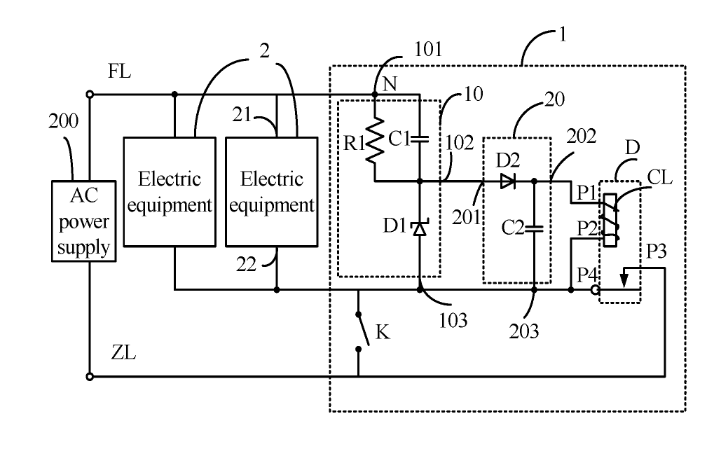

### BACKGROUND

1. Technical Field

The present disclosure relates to circuits, and particularly to a protection circuit for electronic apparatus.

2. Description of Related Art

Items of electronic apparatus, such as TV sets, air conditioners, tablet computers, and washers, are powered by the alternating current (AC) power supply. When there is a sudden blackout, power plugs of the electronic apparatus should be unplugged to prevent the apparatus from any damage when the AC power supply is reconnected suddenly. However, people often forget to unplug the power supply following a blackout.

A protection circuit for electronic apparatus, to overcome the described limitations is thus needed.

### BRIEF DESCRIPTION OF THE DRAWINGS

Many aspects of the present disclosure are better understood with reference to the drawing. The components in the drawing are not necessarily drawn to scale, the emphasis instead being placed upon clearly illustrating the principles of the present disclosure.

The FIGURE is a circuit diagram of an electronic apparatus protection circuit, in accordance with an exemplary embodiment.

### DETAILED DESCRIPTION

Embodiments of the present disclosure will be described with reference to the accompanying drawing.

The FIGURE illustrates a protection circuit 1 for protecting electronic apparatus (protection circuit 1) of the embodiment. The protection circuit 1 includes a relay D, a reset switch K, a voltage conversion circuit 10, and a rectifier circuit 20. The protection circuit 1 is connected between an alternating current (AC) power supply 200 (to which line FL and line ZL are connected), and at least one item of electronic apparatus 2 (electronic apparatus 2). The protection circuit 1 protects the at least one electronic apparatus 2 when there is a sudden electrical blackout.

The relay D includes a first coil terminal P1 and a second coil terminal P2 of a coil CL, a normally open end P3, and a normally closed end P4. When current flows through the coil CL, the ends P3 and P4 are electrical connected. When no current flows through the coil CL, the ends P3 and P4 are electrical disconnected. In the embodiment, the relay D is an electromagnetic relay. The reset switch K is a normally off switch, namely, the reset switch K turns on and conducts electricity when pressed or operated and resumes the disconnected off state when the press or operation is ended. The relay D and the reset switch together provide an electrical latching function.

The ends P3 and P4 of the relay D and the reset switch K are connected in parallel between the AC power supply 200 and each item of electronic apparatus. The ends P3 and P4 of the relay D and the reset switch K are also connected in parallel between the AC power supply 200 and every one of the voltage conversion circuit 10, the rectifier circuit 20, and the coil CL.

An electrical connection is made between the at least one item of electronic apparatus 2 and the AC power supply 200 either when the reset switch K is turned on or when the end P3 contacts the end P4. Then the at least one electronic apparatus 2 is powered by the AC power supply 200. As long as the reset switch is not operated, when the end P3 is disconnected from the end P4, the AC power supply 200 is cut off, and the at least one electronic apparatus 2 is powered off.

In the embodiment, when the reset switch K is turned on or when the end P3 contacts the end P4, the electrical connections between the AC power supply 200, the voltage conversion circuit 10, the rectifier circuit 20, and the coil CL are all re-established.

The voltage conversion circuit 10 converts a voltage of the AC power supply 200 to a low voltage AC, such as 10 volts AC. The rectifier circuit 20 converts the low voltage (10 volts) AC to a direct current voltage and powers the coil CL of the relay D with the direct current voltage. Therefore, once the coil CL of the relay D is energized and ends P3 and P4 are in contact with each other, the at least one electronic apparatus 2 is powered by the AC power supply 200.

When the AC power supply 200 is cut off, the voltage conversion circuit 10 stops outputting the low voltage AC, and the rectifier circuit 20 stops outputting the direct current voltage. Then, as described above, the ends P3 and P4 detach from each other, and the electrical connection between the electronic apparatus 2 and the main power supply is cut. When the AC power supply 200 is provided again, the electrical connection between the at least one electronic apparatus 2 and the AC power supply 200 remains cut off, preventing the at least one electronic apparatus 2 from current or voltage surge or spike and consequent damage when the AC power supply 200 is resupplied.

After the AC power supply 200 has been resupplied, when the reset switch K is operated, power is again provided to the voltage conversion circuit 10, the rectifier circuit 20, and the coil CL. Namely, the AC power supply 200 is re-established. Then the voltage conversion circuit 10 and the rectifier circuit 20 execute their function as described above, and the ends P3 and P4 are again brought into contact. Even after the press or operation on the reset switch K is finished, the end P3 maintains contact with the end P4, again providing an electrical connection between the at least one electronic apparatus 2 and the AC power supply 200.

In detail, as shown in the FIGURE, each of the at least one electronic apparatus 2 includes a power end 21 and a ground end 22. The voltage conversion circuit 10 includes an input end 101, an output end 102, and a ground end 103. The rectifier circuit 20 includes an input end 201, an output end 202, and a ground end 203. The power end 21 of each electronic apparatus 2 and the input end 101 of the voltage conversion circuit 10 are connected to the firing line FL of the AC power supply 200. The input end 201 of the rectifier circuit 20 is connected to the output end 102 of the voltage conversion circuit 10. The first coil terminal P1 is connected to the output end 202 of the rectifier circuit 20, and the second coil terminal P2 is connected to the end P4.

The ground end 22 of each electronic apparatus 2, the ground end 103 of the voltage conversion circuit 10, the ground end 203 of the rectifier circuit 20, and the end P4 are all connected to the zero line ZL, via the end P3 and the end P4 or by the reset switch K. Then, when the reset switch K is turned on, the electrical connection between the at least one electronic apparatus 2 and AC power supply 200 is re-established. When the reset switch is undisturbed and the end P3 is detached from the end P4, the electrical connection between the at least one electronic apparatus 2 and the AC power supply 200 is cut off, and the at least one electronic apparatus 2 is powered off.

When the AC power supply 200 is cut off, as described above, there is no current flowing through the coil CL, the normally open end P3 is detached from the normally closed end P4. At the same time, the reset switch K is at off state if no operation is applied to it, the electrical connection between the ground ends 22, 103, 203 and the zero line ZL is cut off. Therefore, the electrical connections between the AC power supply 200 and the at least one electronic apparatus 2, the voltage conversion circuit 10, the rectifier circuit 20, and the coil CL are cut.

When the AC power supply 200 provides power suddenly, because the electrical connection between the ground end 22 of the at least one electronic apparatus 2, the ground end 103 of the voltage conversion circuit 10, the ground end 203 of the rectifier circuit 20, and the zero line ZL are cut. Then the electrical connection between the at least one electronic apparatus 2 and the AC power supply 200 remains cut off, preventing the at least one electronic apparatus 2 from current or voltage surge or spike and consequent damage when the AC power supply 200 is resupplied.

When the reset switch K is operated, the electrical connection between the ground end 22 of the at least electronic apparatus 2, the ground end 103 of the voltage conversion circuit 10, the ground end 203 of the rectifier circuit 20, and the zero line ZL is established. Then the AC power supply 200 provides power to the at least one electronic apparatus 2, the voltage conversion circuit 10, and the rectifier circuit 20. Then the voltage conversion circuit 10 and the rectifier circuit 20 execute their function as described above, and the ends P3 and P4 are again brought into contact. Even after the press or operation on the reset switch K is finished, the end P3 maintains contact with the end P4, again providing the electrical connections between the ground end 22 of the at least one electronic apparatus 2, the ground end 103 of the voltage conversion circuit 10, the ground end 203 of the rectifier circuit 20, and the zero line ZL. Then the electronic apparatus 2 is powered by the AC power supply 200 normally.

As shown in the FIGURE, the voltage conversion circuit 10 includes a resistor R1, a first capacitor C1, and a regulator D1. The resistor R1 and the first capacitor C1 are connected in parallel between the firing line FL and a cathode (not labeled) of the regulator D1. An anode (not labeled) of the regulator D1 is grounded and constitutes the ground end 103 of the voltage conversion circuit 10. The cathode constitutes the output end 102 of the voltage conversion circuit 10. A connection node N of the resistor R1 and the first capacitor C1, connected to the firing line FL, constitutes the input end 101 of the voltage conversion circuit 10.

The rectifier circuit 20 includes a diode D2 and a second capacitor C2. The capacitor C2 is connected between a cathode (not labeled) of the diode D2 and ground. The cathode of the diode D2 constitutes the output end 202, the end of the capacitor C2, which is grounded, constitutes the ground end 203. An anode (not labeled) of the diode D2 is connected to the output end 102 of the voltage conversion circuit 10 and constitutes the input end 201 of the rectifier circuit 20.

In another embodiment, the reset switch K and the ends P3 and P4 are located between the firing line FL of the AC power supply 200 and each of the power end 21, the input ends 101 and 102, and the coil CL.

In one embodiment, the at least one electronic apparatus 2 includes at least one of a TV set, a computer, an air conditioner, and a refrigerator for example.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A protection circuit for protecting at least one electronic apparatus, the protection circuit comprising:
a relay comprising a coil, a normally open end, and a normally closed end; wherein, the normally open end contacts with the normally closed end when there is a current flowing through the coil;
a reset switch, which is a normally off switch, is switched on in response to an operation thereon;
a voltage conversion circuit configured to convert a voltage of an alternating current (AC) power supply to a low voltage AC when an electrical connection between the voltage conversion circuit and the AC power supply is established; and
a rectifier circuit, connected between the voltage conversion circuit and the coil, configured to convert the low voltage AC to a direct current voltage and power the coil with the direction current voltage;
wherein, the ends of the relay and the reset switch are connected in parallel between the AC power supply and each electronic apparatus; an electrical connection between the at least one electronic apparatus and AC power supply is established either when the reset switch is turned on or when the normally open end contacts the normally closed end; the electrical connection between the at least one electronic apparatus and the AC power supply is cut off when the reset switch is not operated and the normally open end is disconnected from the normally closed end.

2. The protection circuit according to claim 1, wherein the normally open end and the normally closed end of the relay and the reset switch are also connected in parallel between the AC power supply and each one of the voltage conversion circuit, the rectifier circuit, and the coil; when the reset switch is turned on and/or the normally open end contacts with the normally closed end, electrical connections between the AC power supply and the voltage conversion circuit, the rectifier circuit, and the coil are established.

3. The protection circuit according to claim 2, wherein when the AC power supply is cut off, the voltage conversion circuit stops converting the voltage of the AC power supply to the low voltage AC, and the rectifier circuit stops outputting the direct current voltage, the normally open end and the normally closed end are detached from each other; when the reset switch is not operated, the electrical connection between the electronic apparatus and the AC power supply is cut off.

4. The protection circuit according to claim 3, wherein after the AC power supply has been resupplied, when the reset switch is being operated, the electrical connection between the at least one electronic apparatus and the AC power supply is established, and the electrical connection between the voltage conversion circuit, the rectifier circuit, the coil, and the AC power supply is established too; and the voltage conversion circuit converts the voltage of the AC power supply to the low voltage AC, and the rectifier circuit outputs the direct current voltage to power the coil and cause the normally open end to contact to the normally closed end, thus maintaining the electrical connection between the at least one electronic apparatus and AC power supply to be established.

5. The protection circuit according to claim 2, wherein each of the at least one electronic apparatus comprises a power end and a first ground end, the voltage conversion circuit comprises a first input end, a first output end, and a second ground end; the rectifier circuit comprises a second input end, a second output end, and a third ground end; and the coil comprises a first coil terminal and a second coil terminal.

6. The protection circuit according to claim 5, wherein the power end of each electronic apparatus and the first input end of the voltage conversion circuit are connected to a firing line of the AC power supply; the second input end of the rectifier circuit is connected to the first output end of the voltage conversion circuit; and the first coil terminal is connected to an output end of the rectifier circuit, and the second coil terminal is connected to the normally closed end , the first ground end, the second ground end, the third ground end, and the normally closed end are all connected to a zero line of the AC power supply via the reset switch or the normally open end and the normally closed end, and the normally open end is connected to the zero line.

7. The protection circuit according to claim 6, wherein when the reset switch is turned on and/or the normally open end contacts with the normally closed end, the first ground end, the second ground end, the third ground end, and the normally closed end are all connected to the zero line of the AC power supply, thus establishing the electrical connection between the AC power supply and each electronic apparatus, and establishing the electrical connection between the AC power supply and the voltage conversion circuit, the rectifier circuit, and the coil.

8. The protection circuit according to claim 6, wherein the voltage conversion circuit comprises a resistor, a first capacitor, and a regulator; the resistor and the first capacitor are parallel connected between the firing line and a cathode of the regulator; an anode of the regulator is grounded and constitutes a ground end of the voltage conversion circuit; the cathode of the regulator constitutes the first output end of the voltage conversion circuit; and a connection node of the resistor and the first capacitor connected to the firing line constitutes the first input end of the voltage conversion circuit.

9. The protection circuit according to claim 6, wherein the rectifier circuit comprises a diode and a second capacitor, the second capacitor is connected between a cathode of the diode and ground, the cathode of the diode constitutes the second output end, the end of the second capacitor which is grounded constitutes the third ground end, an anode of the diode is connected to the first output end of the voltage conversion circuit and constitutes the second input end of the rectifier circuit.

10. The protection circuit according to claim 1, wherein the relay is an electromagnetic relay.

11. The protection circuit according to claim 1, wherein each electronic apparatus is one selected from the group consisting of a TV set, a computer, an air conditioner, and a refrigerator.
